(19) United States
(12) Patent Application Publication
(10) Pub. No.: US 2011/0062119 A1
(43) Pub. Date: Mar. 17, 2011

(54) UNDERWATER MARKING WITH A PLASMA ARC TORCH

(75) Inventors: Joseph V. Warren, JR., Florence, SC (US); Roger W. Burrows, Quinby, SC (US)

(73) Assignee: The ESAB Group, Inc.

(21) Appl. No.: 12/881,608

(22) Filed: Sep. 14, 2010

Related U.S. Application Data
(60) Provisional application No. 61/242,175, filed on Sep. 14, 2009.

(51) Int. Cl. B23K 10/00

(52) U.S. Cl. 219/72

(57) ABSTRACT

A method of marking underwater with a plasma arc torch is provided. The method includes surrounding a plasma arc produced by the plasma arc torch with a flow of gas. The flow of gas may be directed around and/or along the body of the plasma arc torch with an air curtain attachment. Directing the flow of gas in this manner generates a protective air curtain which substantially surrounds the plasma arc. A current between 8 and 35 amperes may be used to mark the workpiece. Thereafter, the workpiece may be cut using the same plasma arc torch with a current between 30 and 750 amperes. The same nozzle and rate of flow of gas may be used for both the marking and cutting operations. Additionally, the workpiece may be kept underwater throughout the marking and cutting operations.

### CROSS REFERENCE TO RELATED APPLICATIONS

This application claims priority from U.S. Provisional Application No. 61/242,175, filed Sep. 14, 2009 which is hereby incorporated herein in its entirety by reference.

### BACKGROUND OF THE INVENTION

1. Field of the Invention

The present application relates to plasma arc torches configured to operate underwater, and associated methods.

2. Description of Related Art

Cutting with plasma arc torches is sometimes conducted underwater to reduce the noise associated with plasma cutting and minimize the adverse environmental impact of the cutting process. The water traps the plasma generated emissions and particulates produced by the cutting that otherwise would be discharged into the air. Additionally, underwater cutting reduces the amount of harmful glare, ultraviolet radiation, and noise to which workers may otherwise be exposed.

### SUMMARY OF VARIOUS EMBODIMENTS

However, thus far the benefits of underwater operation of plasma arc torches have not been realized for marking.

The present disclosure in one aspect describes a method of operating a plasma arc torch on a workpiece. The method comprises submerging a surface of the workpiece underwater, producing a plasma arc with the plasma arc torch, and substantially surrounding the plasma arc with a flow of gas. The surface of the workpiece may be submerged at least two (2) inches underwater in some embodiments. The method further includes submerging at least a portion of the plasma arc torch underwater, and directing the plasma arc substantially surrounded by the flow of gas at the surface of the workpiece which is submerged underwater. The method also includes marking the surface of the workpiece which is submerged underwater with the plasma arc, whereby the plasma arc penetrates through only a portion of the thickness of the workpiece. The current used to produce the plasma arc during the operation of marking the workpiece may be between eight (8) and thirty-five (35) amperes

In some embodiments the method may further comprise directing the flow of gas at least one of around and along a body of the plasma arc torch to thereby generate a swirling protective air curtain which substantially surrounds the plasma arc, such as by using an air curtain attachment mounted on the body of the plasma arc torch. Thereby the method may further comprise directing the flow of gas between a nozzle of the plasma arc torch and the air curtain attachment and out of an outlet defined between the nozzle and the air curtain attachment.

In additional embodiments, the method may further comprise cutting completely through the thickness of the workpiece with the plasma arc produced by the plasma arc torch, and this may be conducted underwater after the marking operation. The current used to produce the plasma arc during the operation of cutting the workpiece may be between thirty (30) and seven-hundred and fifty (750) amperes. The method may further comprise maintaining the flow of gas at a substantially constant rate of flow at least throughout the operations of marking the workpiece and cutting the workpiece. Additionally, the nozzle of the plasma arc torch may not need to be replaced with an alternate nozzle between the operations of marking the workpiece and cutting the workpiece.

### BRIEF DESCRIPTION OF THE SEVERAL VIEWS OF THE DRAWING(S)

Having thus described the embodiments in general terms, reference will now be made to the accompanying drawings, which are not necessarily drawn to scale, and wherein:

FIG. 1A illustrates a top view of a water table according to an example embodiment;

FIG. 1B illustrates a side view of the water table of FIG. 1A according to an example embodiment;

FIG. 2 illustrates an air curtain attachment according to an example embodiment;

FIG. 3 illustrates a dry table according to an example embodiment;

FIG. 4 illustrates an alternate example embodiment of an air curtain attachment; and

FIG. 5 illustrates a method of operating a plasma arc torch on a workpiece according to an example embodiment.

### DETAILED DESCRIPTION OF THE DRAWINGS

Apparatuses and methods for marking a workpiece underwater now will be described more fully hereinafter with reference to the accompanying drawings in which some but not all embodiments are shown. Indeed, the present development may be embodied in many different forms and should not be construed as limited to the embodiments set forth herein; rather, these embodiments are provided so that this disclosure will satisfy applicable legal requirements. Like numbers refer to like elements throughout.

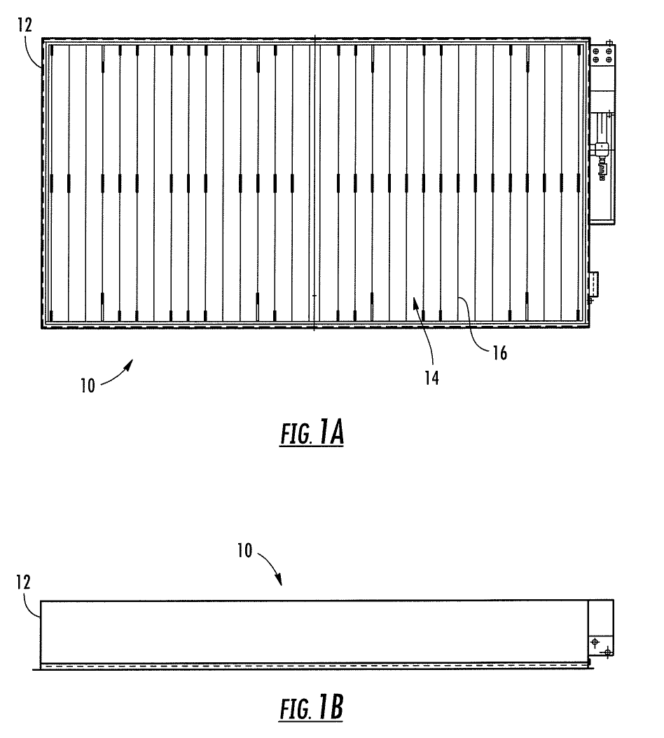

One operation for which plasma arc torches are commonly used is cutting, wherein the plasma arc produced by the plasma arc torch cuts completely through the workpiece. Previously, one method of plasma arc cutting was to cut the workpiece underwater, using a water table. Water tables, such as the embodiment of a water table 10 illustrated in FIG. 1A-1B, may comprise an elevated tub 12 with a grate 14 comprising a plurality of metal bars 16 positioned therein. The grate 14 supports the workpiece which is to be operated upon. Prior to operation, the water table 10 fills with water or the grate 14 descends such that the workpiece is submerged under the water. In embodiments of water tables wherein the water level rises, this may occur via pumping water into the water table, or flowing compressed air into a chamber which displaces the water, and thereby causes the water level to rise. After the workpiece is submerged, the head of a plasma arc torch is also submerged into the water.

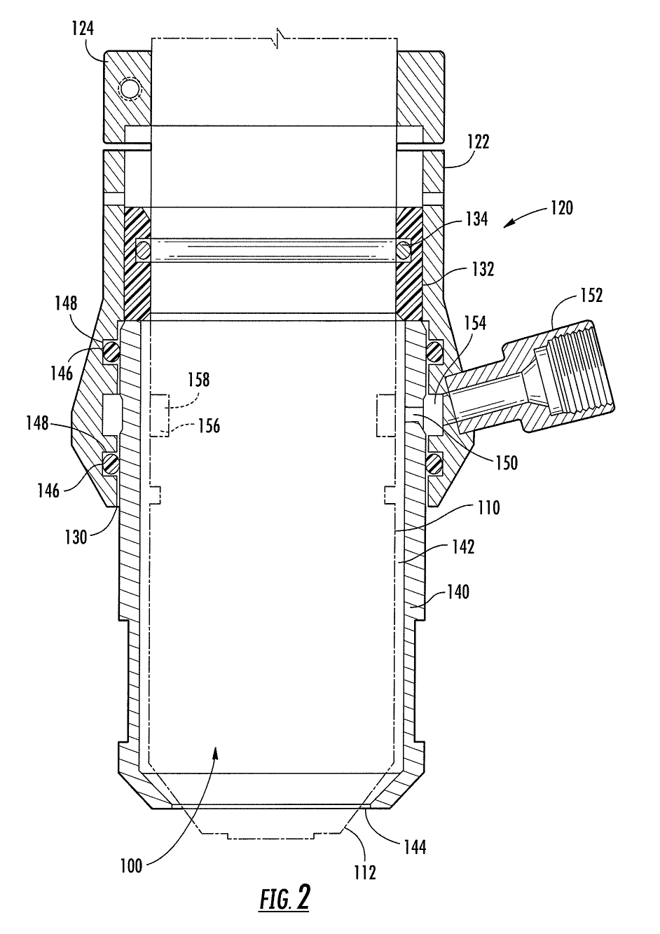

During cutting an “air curtain” or “gas bubble” is formed by a flow of gas near the cutting zone. This protects the plasma arc from being extinguished by the water. Using such a configuration, the gaseous emissions produced by the cutting may be captured by the water. Additionally, noise and ultraviolet light emissions produced by the cutting operation may be reduced. Although the air curtain may be produced by many different types of structures, one embodiment of an air curtain attachment 120 is illustrated in FIG. 2 for exemplary purposes. Further, although the attachment will be described as an additional structure which is coupled to the plasma arc torch, the attachment may also be manufactured so as to be integral with the plasma arc torch.

As illustrated in FIG. 2, the example attachment 120 includes a cylindrical support body 122 formed from a material such as chromium plated brass. The cylindrical support body 122 includes a split upper portion 124, which forms a clamping collar. A socket head cap screw (not shown) joins both sides of the clamp together to secure the cylindrical support body 122 to the outer surface of a plasma arc torch 100 (shown in phantom). The cylindrical support body 122 extends in spaced relation from a torch body 110 defined by the plasma arc torch 100, and forms an annular opening 130.

An insulating sleeve 132 is positioned between the cylindrical support body 122 and the plasma arc torch 100 for insulating the cylindrical support body from the torch body 110. In this regard, the insulating sleeve 132 may be formed of a low grade phenolic. The insulating sleeve 132 may be secured to the inside surface of the cylindrical support body 122. An O-ring 134 is secured within an internal groove of the insulating sleeve 132 and helps secure the insulating sleeve to the torch body 110. During installation the cylindrical support body 122 and the insulating sleeve 132 may be slid onto the torch body 110 and positioned as shown in FIG. 2.

A cylindrical sleeve 140 is received into the annular opening 130 of the cylindrical support body 122. The cylindrical sleeve 140 may be formed of anodized aluminum to form a light-weight, but strong structure that is resistant to corrosion. The cylindrical sleeve 140 extends in spaced relation along the front end of the torch body 110 to define an annular air chamber 142 extending along the front end and forming an annular outlet opening 144 positioned adjacent a nozzle 112 of the plasma arc torch 100. The rear portion of the cylindrical sleeve 140 is received in the annular opening 130. O-rings 146 are secured within annular grooves 148, and help retain the cylindrical sleeve 140 to the cylindrical support body 122. The outlet opening 144 defined by the cylindrical sleeve 140 may be between about 1/32 inch to about 1/16 inch.

As further illustrated in FIG. 2, the lower portion of the cylindrical support body 122 is diametrically enlarged to allow enough room to create the annular grooves 148 in which the O-rings 146 are positioned. At least one air channel orifice 150 also extends from the diametrically enlarged portion through the cylindrical support body 122 and the cylindrical sleeve 140. The air channel orifice 150 terminates at the annular air chamber 142 and allows a high velocity gas to be injected into the annular air chamber 142 in swirling relation downward around and/or along the front end of the torch body 110 and through the outlet opening 144 for generating an evenly formed protective air curtain. An air fitting 152 is mounted on the diametrically enlarged portion of the cylindrical support body 122 and communicates with the air channel orifice 150. Standard hoses (not shown) screw into the air fitting 152 and provide a source of high velocity gas. An enlarged air plenum 154 is defined between the cylindrical sleeve 140 and the inner surface of the cylindrical support body 122. Thus, high velocity gas is first injected into the air plenum 154 before passing into the annular air chamber 142.

The annular air chamber 142 also includes an enlarged air plenum 156 into which air is injected before passing downward through the annular air channel 142. The torch body 110 has an annular groove 158 which forms the enlarged air plenum 156. During operation, the high velocity gas is discharged into the air channel orifice 150 and into the first plenum chamber 154 as mentioned above. In one embodiment, the gas is distributed in the plenum chamber 154 and then moves through a plurality of evenly spaced orifices 150 that extend tangentially into the second plenum chamber 156. The tangentially inclined orifices 150 provide a swirling gas flow within the plenum chamber 156. The high velocity gas swirls downward through the annular air channel 142 around and along the torch body 110 and is discharged through the outlet 144 to form a protective air curtain for the plasma arc. The swirling high velocity gas forms an evenly distributed air curtain which helps prevent water flowing into the cutting zone. Additionally, the swirling high velocity gas expands outward after exiting the outlet 144 and forms a larger diameter air curtain than may be accomplished with other constructions. Thus, the water may be less prone to flow into the cutting zone than with other constructions.

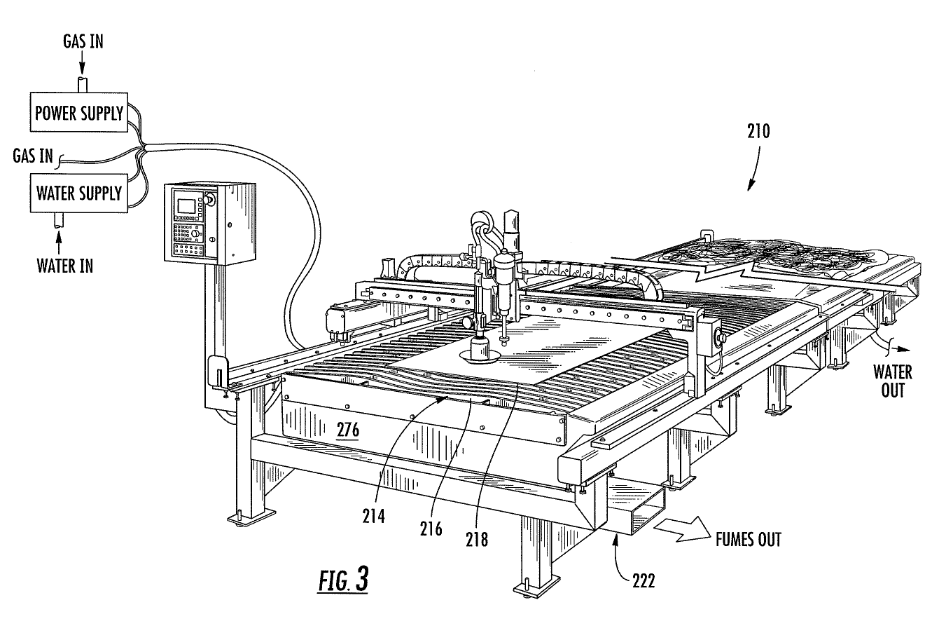

Accordingly, underwater cutting may conducted using embodiments of an air curtain attachment as described above. However, the expense and effort required to dispose of the used water and clean the water table resulted in an industry shift to use of dry tables. Dry tables, such as the embodiment of a dry table 210 illustrated in FIG. 3 typically rely on a downdraft system whereby a grate 214 comprising a plurality of metal bars 216 is positioned on top of a plenum 276 configured to suck the fumes emitting from the cutting operation down and through an exhaust 222 away from the workpiece 218 which is being operated on. The fumes may thereafter be filtered or otherwise treated before being exhausted to the environment. However, use of dry tables may be less effective at treating the emitted fumes. Additionally, dry table fume removal systems are also expensive, and they may not reduce the noise produced during cutting or the ultraviolet emissions from the plasma arc. Accordingly, there has been a trend to return to use of water tables for underwater cutting, particularly in Europe where some locations have stricter pollution limitations than in the United States. However, marking, which is another common operation conducted with a plasma arc torch, has thus far complicated the use of water tables by being conducted above water, as will be explained below.

Marking is an operation in which the plasma arc penetrates into the thickness of a workpiece only superficially. In order to accomplish this, marking uses a current which is relatively low as compared to a current used for cutting. For example, cutting with a plasma torch may involve use of currents in the range of thirty (30) to seven-hundred and fifty (750) amperes, whereas marking may involve currents in the range of eight (8) to thirty-five (35) amperes. Due to use of a much lower current, the fume, noise, and light emissions produced during marking may be significantly less than those produced by cutting. Accordingly, there has not been a motivation to conduct marking underwater.

Further, it was not expected that a plasma arc with a marking current would be able to operate underwater. In this regard, even the inventors of the present application were skeptical that a plasma arc would function underwater with a marking current. The inventors feared that a low current arc would be extinguished by the water. These fears were confirmed when the inventors attempted to mark underwater with a plasma arc torch lacking an air curtain attachment, and the plasma arc was found to be unstable and had a tendency to extinguish. The inventors suspected that the low current plasma arc would similarly extinguish when used in conjunction with an air curtain. This expectation was based on the inventors' knowledge that when an air curtain is used, there is still some water splashing around inside the air curtain, and the surface of the workpiece remains wet.

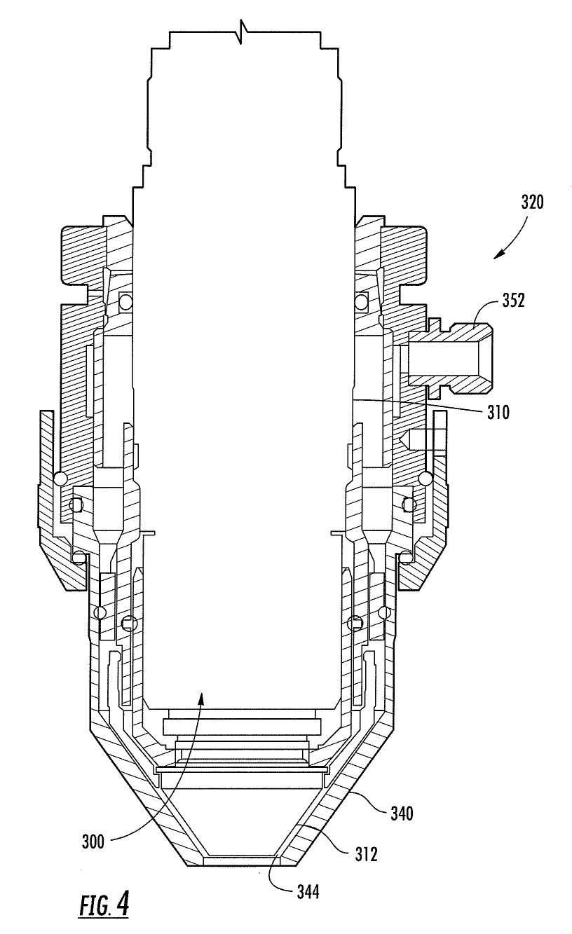

Despite the skepticism of the inventors, an experiment was performed using a plasma arc torch having an air curtain attachment. An embodiment of a plasma arc torch 300 with an air curtain attachment 320 used in the experiment is illustrated in FIG. 4. Although the air curtain attachment 320 differs from the air curtain attachment 120 shown in FIG. 2 and described above, the functionality and principles of operation are substantially the same. For example, a flow of gas enters the air curtain attachment 320 through an air fitting 352 and is directed around and/or along the torch body 310 to thereby generate a swirling protective air curtain which substantially surrounds a plasma arc produced by the plasma arc torch 300. Thereafter, the gas is directed between a nozzle 312 of the plasma arc torch 300 and a sleeve 340 of the air curtain attachment 320. Finally, the flow of gas exits through an annular outlet opening 344 to produce the swirling protective air curtain.

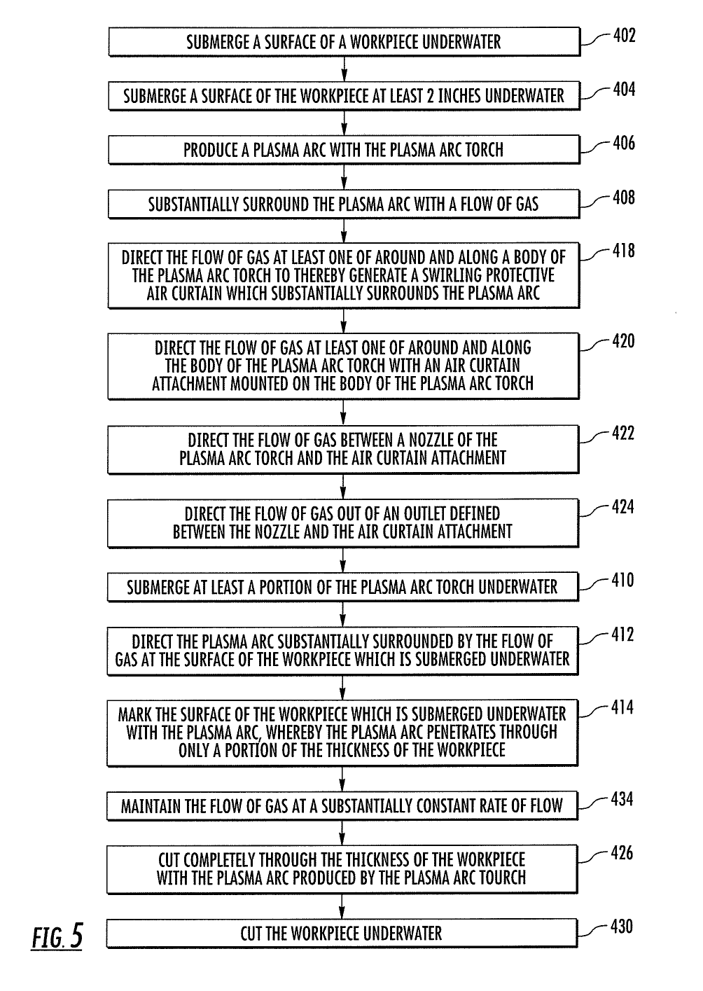

To the surprise of the inventors, a stable plasma arc was produced within the air curtain despite using a current configured for marking. Thus, the plasma arc torch was able to mark a workpiece. Accordingly, a method of operating a plasma arc torch on a workpiece was developed, as illustrated in FIG. 5. The method comprises an operation 402 of submerging a surface of the workpiece underwater. Further, as indicated at operation 404, the method may comprise submerging the workpiece at least 2 inches underwater. Additionally, the method includes an operation 406 of producing a plasma arc with the plasma arc torch, and an operation 408 of substantially surrounding the plasma arc with a flow of gas. The method further comprises submerging at least a portion of the plasma arc torch underwater at operation 410. For example, at least the nozzle may be submerged underwater. Also, the method may include directing the plasma arc substantially surrounded by the flow of gas at the surface of the workpiece which is submerged underwater at operation 412. Further, the method comprises marking the surface of the workpiece which is submerged underwater with the plasma arc, whereby the plasma arc penetrates through only a portion of the thickness of the workpiece at operation 414. A first current used to produce the plasma arc during the operation 414 of marking the workpiece may be between eight (8) and thirty-five (35) amperes in one embodiment.

With regard to the operation 408 of substantially surrounding the plasma arc with a flow of gas, the method may further comprise an operation 418 of directing the flow of gas at least one of around and along a body of the plasma arc torch to thereby generate a swirling protective air curtain which substantially surrounds the plasma arc. Further, an air curtain attachment mounted on the body of the plasma arc torch may direct the flow of gas around and/or along the body of the plasma torch at operation 420. For example, either of air curtain attachments 120 and 320 illustrated in FIGS. 2 and 4 may be used. Additionally, at operation 422, the flow of gas may be directed between a nozzle (for example, nozzle 112 or 312), and the air curtain attachment. Thereafter, the flow of gas may be directed out of an outlet defined between the nozzle and the air curtain attachment (for example, the annular outlet opening 144, 344) at operation 424.

Further, the method may comprise cutting completely through the thickness of the workpiece with the plasma arc produced by the plasma arc torch at operation 426. The cutting operation 426 may be conducted after the marking operation 414 because the workpiece might shift positions after being cut, although other orders of operation are possible. The cutting operation 426 may use a current of between thirty (30) and seven-hundred and fifty (750) amperes to produce the plasma arc. Further, the cutting operation 426 may be conducted underwater, as noted at operation 430. As shown at operation 434, the flow of gas may be maintained at a substantially constant rate of flow at least throughout the marking operation 414 and the cutting operation 426. Additionally, the nozzle need not be replaced with an alternate nozzle between the operations 414, 426 of marking the workpiece and cutting the workpiece.

Accordingly a method of marking and a method of marking in conjunction with cutting is provided. The method of marking underwater provides great efficiency benefits which have hereto been unrealized for the various reasons discussed above. Now, as a result of marking and cutting both being conducted underwater, there is no need to raise or lower the level of the water with respect to the workpiece between the marking and cutting steps. Previously, since methods of marking underwater using a plasma arc torch were not available, it was necessary to mark above water, which involved raising or lowering the water level in between cutting and marking, depending on the order of operation. Further, as a result of the use of a single nozzle and the same gas flow rate for the air curtain for both the marking and cutting steps, rapid changes from marking to cutting and vice versa may occur. Therefore, the methods presented herein achieve the unexpected result of being able to both cut and mark underwater, which may provide significant cost savings as a result of not requiring lowering or raising the water level. Further, the methods achieve the advantages of reduced fume, light, and noise pollution, as discussed above.

Many modifications and other embodiments will come to mind to one skilled in the art to which these embodiments pertain having the benefit of the teachings presented in the foregoing descriptions and the associated drawings. Therefore, it is to be understood that modifications and other embodiments are intended to be included within the scope of the appended claims. Although specific terms are employed herein, they are used in a generic and descriptive sense only and not for purposes of limitation.

That which is claimed:

1. A method of operating a plasma arc torch on a workpiece, comprising:
submerging a surface of the workpiece underwater;
producing a plasma arc with the plasma arc torch;
substantially surrounding the plasma arc with a flow of gas;
submerging at least a portion of the plasma arc torch underwater;
directing the plasma arc substantially surrounded by the flow of gas at the surface of the workpiece which is submerged underwater; and
marking the surface of the workpiece which is submerged underwater with the plasma arc, whereby the plasma arc penetrates through only a portion of the thickness of the workpiece.

2. The method of claim 1, further comprising directing the flow of gas at least one of around and along a body of the plasma arc torch to thereby generate a swirling protective air curtain which substantially surrounds the plasma arc.

3. The method of claim 2, further comprising directing the flow of gas at least one of around and along the body of the plasma arc torch with an air curtain attachment mounted on the body of the plasma arc torch.

4. The method of claim 3, further comprising directing the flow of gas between a nozzle of the plasma arc torch and the air curtain attachment.

5. The method of claim 4, further comprising directing the flow of gas out of an outlet defined between the nozzle and the air curtain attachment.

6. The method of claim 1, wherein a first current used to produce the plasma arc while marking the workpiece is between 8 and 35 amperes.

7. The method of claim 1, wherein submerging the surface of the workpiece comprises submerging the surface of the workpiece at least 2 inches underwater.

8. The method of claim 1, further comprising cutting completely through the thickness of the workpiece with the plasma arc produced by the plasma arc torch.

9. The method of claim 8, wherein cutting the workpiece comprises cutting the workpiece underwater.

10. The method of claim 8, wherein marking the workpiece occurs before cutting the workpiece.

11. The method of claim 8, wherein a second current used to produce the plasma arc while cutting the workpiece is between 30 and 750 amperes.

12. The method of claim 8, further comprising maintaining the flow of gas at a substantially constant rate of flow at least throughout marking the workpiece and cutting the workpiece.

13. The method of claim 8, wherein the plasma arc torch comprises a nozzle, and wherein the nozzle is not replaced with an alternate nozzle between marking the workpiece and cutting the workpiece.
